(19) United States
(12) Patent Application Publication
(10) Pub. No.: US 2013/0174470 A1
(43) Pub. Date: Jul. 11, 2013

(54) Pest-Management Apparatus

(71) Applicants: Ethan VICKERY, Bedford, TX (US); Larry COVINGTON, Bedford, TX (US)

(72) Inventors: Ethan VICKERY, Bedford, TX (US); Larry COVINGTON, Bedford, TX (US)

(21) Appl. No.: 13/711,737

(22) Filed: Dec. 12, 2012

Related U.S. Application Data
(60) Provisional application No. 61/570,116, filed on Dec. 13, 2011.

(51) Int. Cl. A01M 25/00; A01M 23/16

(52) U.S. Cl. CPC A01M 25/004; A01M 23/16
USPC 43/124

(57) ABSTRACT

Pest-management apparatuses (e.g., stations), such as, for example, that can be configured to permit a rodent to enter and retrieve a bait and/or become trapped (e.g., via adhesive or a snap-trap).

### CROSS-REFERENCE TO RELATED APPLICATIONS

This applications claims the benefit of U.S. Provisional Patent Application No. 61/570,116 filed Dec. 13, 2011, which is incorporated by reference in its entirety.

### BACKGROUND

1. Field of the Invention

The present invention relates generally to pest (e.g., rodent) management and, more particularly, but not by way of limitation, to pest-management apparatuses and methods.

2. Brief Description of Related Art

Examples of pest-management apparatuses are disclosed in U.S. Pat. No. 4,026,068; U.S. Pat. No. 4,028,829; U.S. Pat. No. 4,660,320; U.S. Pat. No. 5,953,854; U.S. Pat. No. 6,082,042; and U.S. Pat. No. 6,343,434.

### SUMMARY OF THE INVENTION

This disclosure includes embodiments of pest-management apparatuses (e.g., stations or bait stations) and methods of use.

Some embodiments of the present pest management apparatuses comprise: a base; and a lid configured to be coupled to the base such that the base and the lid cooperate to define a chamber having at least one entrance opening sized to permit a rodent to enter the apparatus through the at least one entrance opening; where at least one of the base and the lid comprises a sidewall at least partially defining an external perimeter of the apparatus, the sidewall configured to discourage a rodent from climbing onto the lid of the apparatus.

In some embodiments, the base comprises the sidewall. In some embodiments, the sidewall is further configured to direct a rodent toward the at least one entrance opening. In some embodiments, the sidewall has a height, and an upper portion of the sidewall is disposed outwardly of a lower portion of the sidewall by a distance of at least 20 percent of the height. In some embodiments, the sidewall includes a surface extending from the lower portion to the upper portion. In some embodiments, the surface is substantially straight between the lower portion and the upper portion. In some embodiments, the surface includes a concave-shaped first portion and a substantially straight second portion. In some embodiments, the lid has a first end and a second end, and one of the first end and the second end is coupled to the base. In some embodiments, the lid is pivotally coupled to the base. In some embodiments, the lid is unitary with the base. In some embodiments, the other of the first and second ends of the lid is configured to be detachably coupled to the base.

In some embodiments, the lid comprises a transparent viewing window through which a user can view at least a portion of the chamber. In some embodiments, the transparent viewing window is at least partially detachable from the lid. In some embodiments, the lid comprises a substantially planar portion and a reinforcing portion. In some embodiments, the reinforcing portion comprises one or more ribs. In some embodiments, the lid is configured such that if the lid is coupled to the body in a closed configuration, the reinforcing portion is interior to the apparatus. In some embodiments, the base comprises a floor configured to prevent movement of the apparatus. In some embodiments, the floor is a unitary portion of the base. In some embodiments, at least one of the base and the lid comprises at least one protrusion extending outwardly relative to the chamber, the at least one protrusion configured to discourage a rodent from traveling in at least one non-vertical direction away from the at least one entrance opening. In some embodiments, the at least one protrusion extends from the sidewall. In some embodiments, the protrusion is unitary with the sidewall. In some embodiments, the chamber has at least one secondary opening sized differently than the entrance opening. In some embodiments, the at least one secondary opening is shaped differently than the at least one entrance opening. In some embodiments, the at least one secondary opening is smaller than the at least one entrance opening. In some embodiments, the at least one secondary opening includes a plurality of secondary openings that are each smaller than the at least one entrance opening.

In some embodiments, the apparatus comprises one or more separators configured such that if the lid and base are coupled together to define the chamber, the one or more separators divide the chamber into a rodent capture portion and an entry portion. In some embodiments, the rodent capture portion and the entry portion are in fluid communication. In some embodiments, the one or more separators comprise two separators spaced to define two pathways between the entry portion and the rodent capture portion of the chamber. In some embodiments, the one or more separators comprise a plurality of separators spaced to define multiple pathways between the entry portion and the rodent capture portion of the chamber. In some embodiments, each of the one or more separators is coupled to at least one of the lid and the base. In some embodiments, at least one of the one or more separators is unitary with the lid or the base. In some embodiments, the apparatus further comprises a divider coupled to the base; where the base is configured such that if multiple rodents enter the apparatus, the divider and the one or more separators direct the rodents to different parts of the rodent capture portion of the chamber. In some embodiments, the apparatus is configured to be coupled to a coupling member such that if the coupling member is coupled to the surface, the coupling member substantially prevents the apparatus from moving away from the surface. In some embodiments, a portion of the coupling member is configured to extend beyond the lid of the apparatus if the apparatus is coupled to the coupling. In some embodiments, the coupling member comprises: a planar portion; and a retaining portion; where the apparatus is configured to be coupled to the retaining portion.

Some embodiments of the present pest-management apparatuses comprise: a base; and a lid configured to be coupled to the base such that the base and the lid cooperate to define a chamber having at least one entrance opening sized to permit a rodent to enter the apparatus through the at least one entrance opening; where at least one of the base and the lid comprises at least one protrusion extending outwardly relative to the chamber, the at least one protrusion configured to discourage a rodent from traveling in at least one non-vertical direction away from the at least one entrance opening. In some embodiments, at least one of the base and the lid comprises a sidewall at least partially defining an external perimeter of the apparatus, and the at least one protrusion extends from the sidewall. In some embodiments, the base comprises the sidewall. In some embodiments, the sidewall is configured to discourage a rodent from climbing onto the lid of the apparatus. In some embodiments, the sidewall is configured to direct a rodent toward the at least one entrance opening. In some embodiments, the sidewall has a height, and an upper portion of the sidewall disposed outwardly of a lower portion of the sidewall by a distance of at least 20 percent of the height. In some embodiments, the sidewall includes a surface extending from the lower portion to the upper portion. In some embodiments, the surface is substantially straight between the lower portion and the upper portion. In some embodiments, the surface includes a concave-shaped first portion and a substantially straight second portion.

In some embodiments, the chamber has at least one secondary opening sized differently than the entrance opening. In some embodiments, the at least one secondary opening is shaped differently than the at least one entrance opening. In some embodiments, the at least one secondary opening is smaller than the at least one entrance opening. In some embodiments, the at least one secondary opening includes a plurality of secondary openings that are each smaller than the at least one entrance opening. In some embodiments, the apparatus comprises one or more separators configured such that if the lid and base are coupled together to define the chamber, the one or more separators divide the chamber into a rodent capture portion and an entry portion. In some embodiments, the rodent capture portion and the entry portion are in fluid communication. In some embodiments, the one or more separators comprise two separators spaced to define two pathways between the entry portion and the rodent capture portion of the chamber. In some embodiments, the one or more separators comprise a plurality of separators spaced to define multiple pathways between the entry portion and the rodent capture portion of the chamber. In some embodiments, each of the one or more separators is coupled to at least one of the lid and the base. In some embodiments, at least one of the one or more separators is unitary with the lid or the base. In some embodiments, the one or more separators are configured such that if multiple rodents enter the apparatus, the one or more separators direct the rodents to different parts of the rodent capture portion of the chamber. In some embodiments, the apparatus is configured to be coupled to a coupling member such that if the coupling member is coupled to the surface, the coupling member substantially prevents the apparatus from moving away from the surface. In some embodiments, a portion of the coupling member is configured to extend beyond the lid of the apparatus if the apparatus is coupled to the coupling. In some embodiments, the coupling member comprises: a planar portion; and a retaining portion; where the apparatus is configured to be coupled to the retaining portion.

Some embodiments of the present pest-management apparatuses comprise: a base; and a lid configured to be coupled to the base such that the base and the lid cooperate to define a chamber having at least one entrance opening sized to permit a rodent to enter the chamber and at least one secondary opening sized differently than the entrance opening. In some embodiments, the at least one secondary opening is shaped differently than the at least one entrance opening. In some embodiments, the at least one secondary opening is smaller than the at least one entrance opening. In some embodiments, the at least one secondary opening includes a plurality of secondary openings that are each smaller than the at least one entrance opening. In some embodiments, the at least one entrance opening and at least one secondary opening is disposed vertically from the ground to prevent fluid entry. In some embodiments, at least one of the base and the lid comprises a sidewall at least partially defining an external perimeter of the apparatus, the sidewall configured to discourage a rodent from climbing onto the lid of the apparatus. In some embodiments, the base comprises the sidewall. In some embodiments, the sidewall is configured to direct a rodent toward the at least one entrance opening. In some embodiments, the sidewall has a height, and an upper portion of the sidewall disposed outwardly of a lower portion of the sidewall by a distance of at least 20 percent of the height. In some embodiments, the sidewall includes a surface extending from the lower portion to the upper portion. In some embodiments, the surface is substantially straight between the lower portion and the upper portion. In some embodiments, the surface includes a concave-shaped first portion and a substantially straight second portion.

In some embodiments, at least one of the base and the lid comprises at least one protrusion extending outwardly relative to the chamber, the at least one protrusion configured to discourage a rodent from traveling in at least one non-vertical direction away from the at least one entrance opening. In some embodiments, the apparatus comprises one or more separators configured such that if the lid and base are coupled together to define the chamber, the one or more separators divide the chamber into a rodent capture portion and an entry portion. In some embodiments, the rodent capture portion and the entry portion are in fluid communication. In some embodiments, the one or more separators comprise two separators spaced to define two pathways between the entry portion and the rodent capture portion of the chamber. In some embodiments, the one or more separators comprise a plurality of separators spaced to define multiple pathways between the entry portion and the rodent capture portion of the chamber. In some embodiments, each of the one or more separators is coupled to at least one of the lid and the base. In some embodiments, at least one of the one or more separators is unitary with the lid or the base. In some embodiments, the one or more separators are configured such that if multiple rodents enter the apparatus, the one or more separators direct the rodents to different parts of the rodent capture portion of the chamber. In some embodiments, the apparatus is configured to be coupled to a coupling member such that if the coupling member is coupled to the surface, the coupling member substantially prevents the apparatus from moving away from the surface. In some embodiments, a portion of the coupling member is configured to extend beyond the lid of the apparatus if the apparatus is coupled to the coupling. In some embodiments, the coupling member comprises: a planar portion; and a retaining portion; where the apparatus is configured to be coupled to the retaining portion.

Some embodiments of the present pest-management apparatuses comprise: a base; and a lid configured to be coupled to the base such that the base and the lid cooperate to define a chamber having at least one entrance opening sized to permit a rodent to enter the apparatus; where the apparatus comprises one or more separators configured such that if the lid and base are coupled together to define the chamber, the one or more separators divide the chamber into a rodent capture portion and an entry portion. In some embodiments, the rodent capture portion and the entry portion are in fluid communication. In some embodiments, the one or more separators comprise two separators spaced to define two pathways between the entry portion and the rodent capture portion of the chamber. In some embodiments, the one or more separators comprise a plurality of separators spaced to define multiple pathways between the entry portion and the rodent capture portion of the chamber. In some embodiments, each of the one or more separators is coupled to at least one of the lid and the base. In some embodiments, at least one of the one or more separators is unitary with the lid or the base. In some embodiments, the apparatus is configured such that if multiple rodents enter the apparatus, the one or more separators direct the rodents to different parts of the rodent capture portion of the chamber. In some embodiments, the rodent capture portion is configured to resist a rodent's exit from the apparatus. In some embodiments, the apparatus further comprises an adhesive disposed in the rodent capture portion. In some embodiments, the adhesive comprises an adhesive mat. In some embodiments, the adhesive mat is coupled to the base. In some embodiments, the adhesive mat is releasably coupled to the base. In some embodiments, the one or more separators are substantially perpendicular to the base. In some embodiments, the one or more separators are angled to direct rodents to the rodent capture portion.

In some embodiments, the apparatus comprises two entrance openings. In some embodiments, the two entrance openings are disposed on substantially opposite sides of the apparatus. In some embodiments, the two entrance openings are configured such that an axis extends through both openings. In some embodiments, the axis is perpendicular to both openings. In some embodiments, the two entrance openings are in fluid communication with the entry portion of the chamber. In some embodiments, at least one of the base and the lid comprises a divider configured to prevent a rodent from entering the apparatus through one of the two openings and exiting the apparatus through the other of the two openings without first passing through the rodent capture portion of the chamber. In some embodiments, the divider is further configured to prevent a rodent outside the apparatus from seeing one of the two openings through the other of the two openings. In some embodiments, at least one of the base and the lid comprises a sidewall, and the apparatus is configured such that if the lid is coupled to the base in a closed configuration, the divider extends from the sidewall. In some embodiments, the base comprises the sidewall. In some embodiments, the divider is unitary with the sidewall. In some embodiments, the divider is disposed substantially midway between the two entrance openings. In some embodiments, the divider is configured to direct rodents toward the rodent capture portion. In some embodiments, the divider is coupled to the base, and the base is configured such that if multiple rodents enter the apparatus, the divider and the one or more separators direct the rodents to different parts of the rodent capture portion of the chamber. In some embodiments, the divider has a first end and a second end disposed closer to the rodent capture portion than the first end. In some embodiments, the second end of the divider is a greater distance from the center of one of the two openings than at least a portion of the first end of the divider. In some embodiments, a distance between the second end of the divider and the center of the one of the two openings is at least 30% greater than the distance between the second end of the divider and the center of the one of the two openings. In some embodiments, the divider includes a surface extending from the second end to the first end.

In some embodiments, the chamber has at least one secondary opening sized differently than the entrance opening. In some embodiments, the at least one secondary opening is shaped differently than the at least one entrance opening. In some embodiments, the at least one secondary opening is smaller than the at least one entrance opening. In some embodiments, the at least one secondary opening includes a plurality of secondary openings that are each smaller than the at least one entrance opening. In some embodiments, at least one of the base and the lid comprises a sidewall at least partially defining an external perimeter of the apparatus, the sidewall configured to discourage a rodent from climbing onto the lid of the apparatus. In some embodiments, the base comprises the sidewall. In some embodiments, the sidewall is configured to direct a rodent toward the at least one entrance opening. In some embodiments, the sidewall has a height, and an upper portion of the sidewall disposed outwardly of a lower portion of the sidewall by a distance of at least 20 percent of the height. In some embodiments, the sidewall includes a surface extending from the lower portion to the upper portion. In some embodiments, the surface is substantially straight between the lower portion and the upper portion. In some embodiments, the surface includes a concave-shaped first portion and a substantially straight second portion. In some embodiments, at least one of the base and the lid comprises at least one protrusion extending outwardly relative to the chamber, the at least one protrusion configured to discourage a rodent from traveling in at least one non-vertical direction away from the at least one entrance opening. In some embodiments, the apparatus is configured to be coupled to a coupling member such that if the coupling member is coupled to the surface, the coupling member substantially prevents the apparatus from moving away from the surface. In some embodiments, a portion of the coupling member is configured to extend beyond the lid of the apparatus if the apparatus is coupled to the coupling. In some embodiments, the coupling member comprises: a planar portion; and a retaining portion; where the apparatus is configured to be coupled to the retaining portion.

Any embodiment of any of the present apparatuses can consist of or consist essentially of—rather than comprise/include/contain/have—any of the described elements and/or features. The same is true of the present methods. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The embodiments of the present pest-management apparatuses and their components shown in the figures are drawn to scale for at least the depicted embodiment.

FIGS. 1-3 depict perspective views of an embodiment of the present pest-management apparatuses having a base and a lid, shown with the lid in an open configuration.

FIG. 4 depicts an upper perspective view of the apparatus of FIG. 1 with the lid in a closed configuration.

FIG. 5 depicts a cross-sectional perspective view (without cross-hatching) of the apparatus of FIG. 1 with the lid in a open configuration, taken along line 5-5 of FIG. 1.

FIG. 6 depicts a left wall view of the apparatus of FIG. 1 with the lid in an open configuration

FIG. 7 depicts a top view of the apparatus of FIG. 1 with the lid in an open configuration.

FIG. 8 depicts a front wall view of the apparatus of FIG. 1.

FIG. 9 depicts a bottom view of the apparatus of FIG. 1 with the lid in an open configuration.

FIGS. 10-11 depict perspective views of another embodiment of a lid of the present pest-management apparatuses.

FIGS. 12-14 depict perspective views of another embodiment of a base of the present pest-management apparatuses.

FIG. 15 depicts a perspective view of a coupling member configured to be coupled to a pest-management apparatus.

FIGS. 16-17 depict perspective views of the coupling member of FIG. 15 coupled to an embodiment of the present pest-management apparatuses.

### DESCRIPTION OF ILLUSTRATIVE EMBODIMENTS

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, a pest-management apparatus or station, or a component of a bait station, that is configured in a certain way is configured in at least that way, but it can also be configured in other ways than those specifically described.

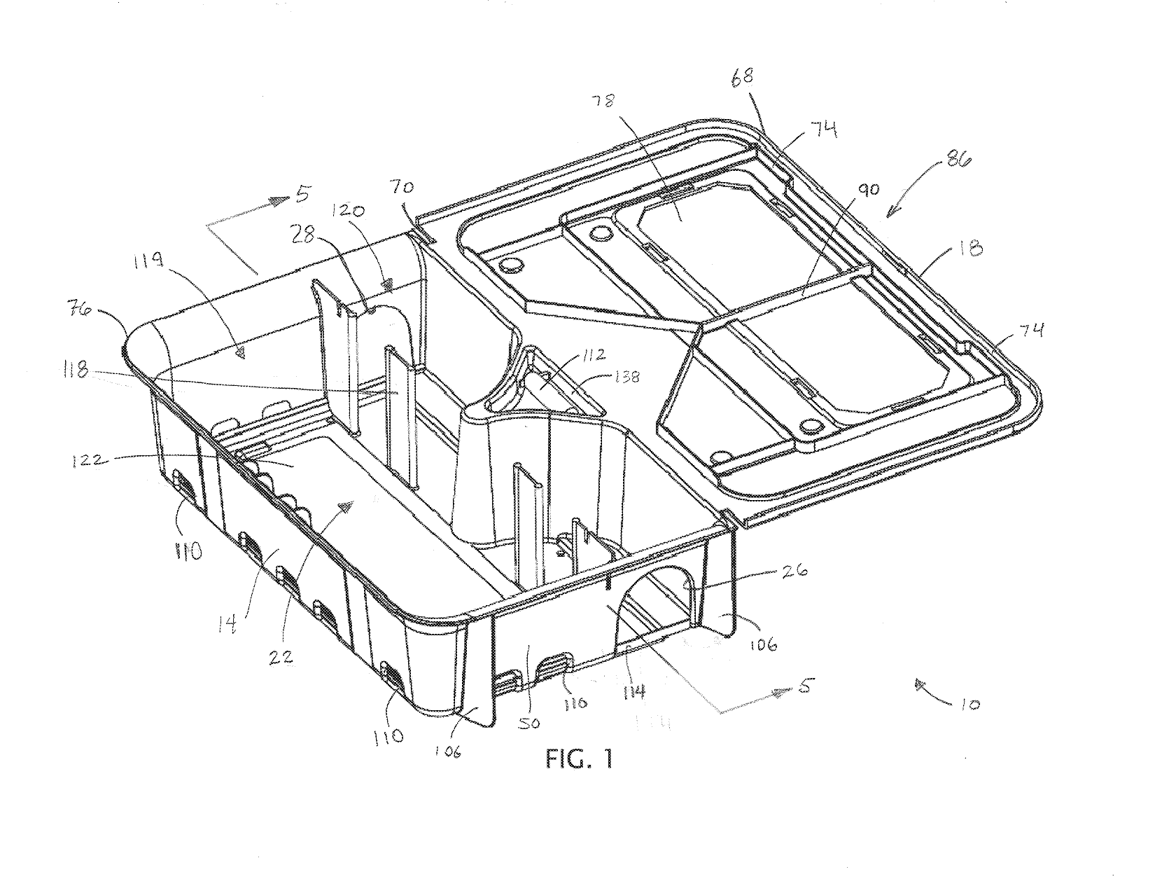

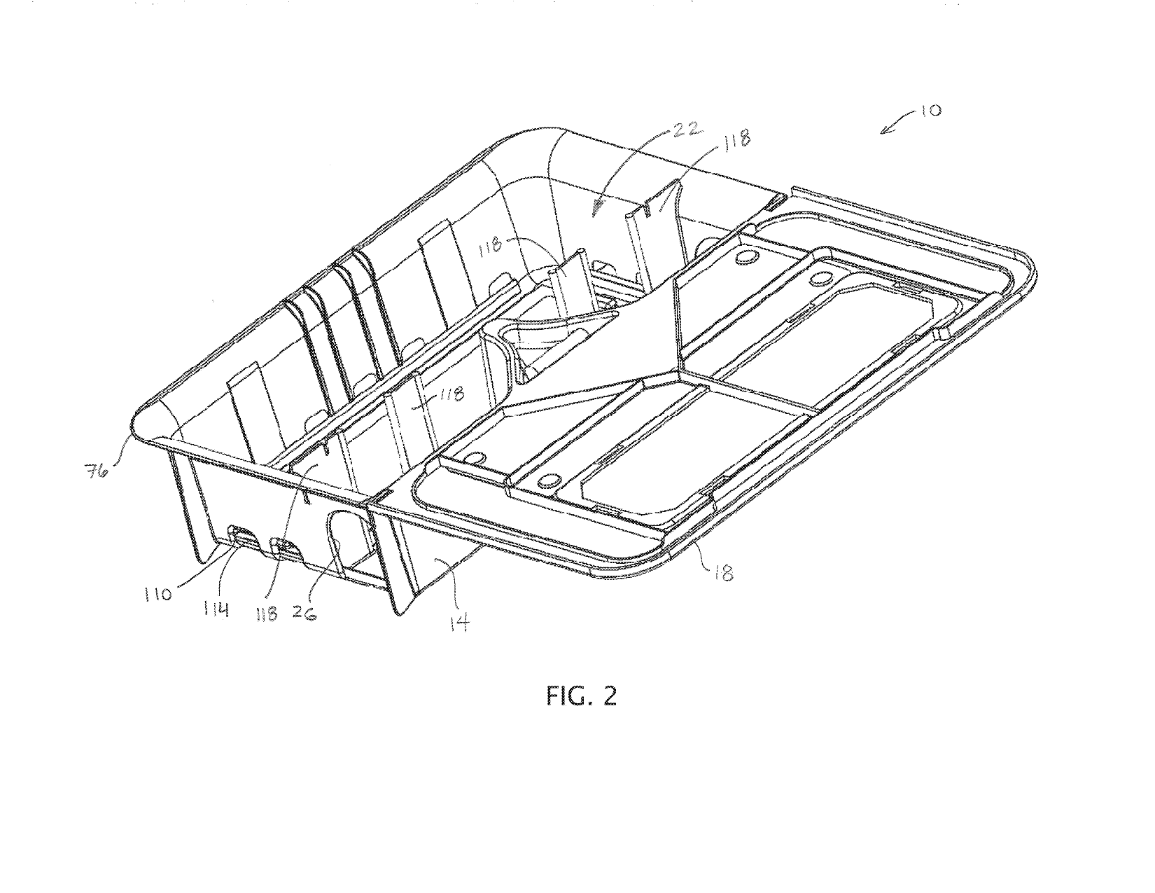

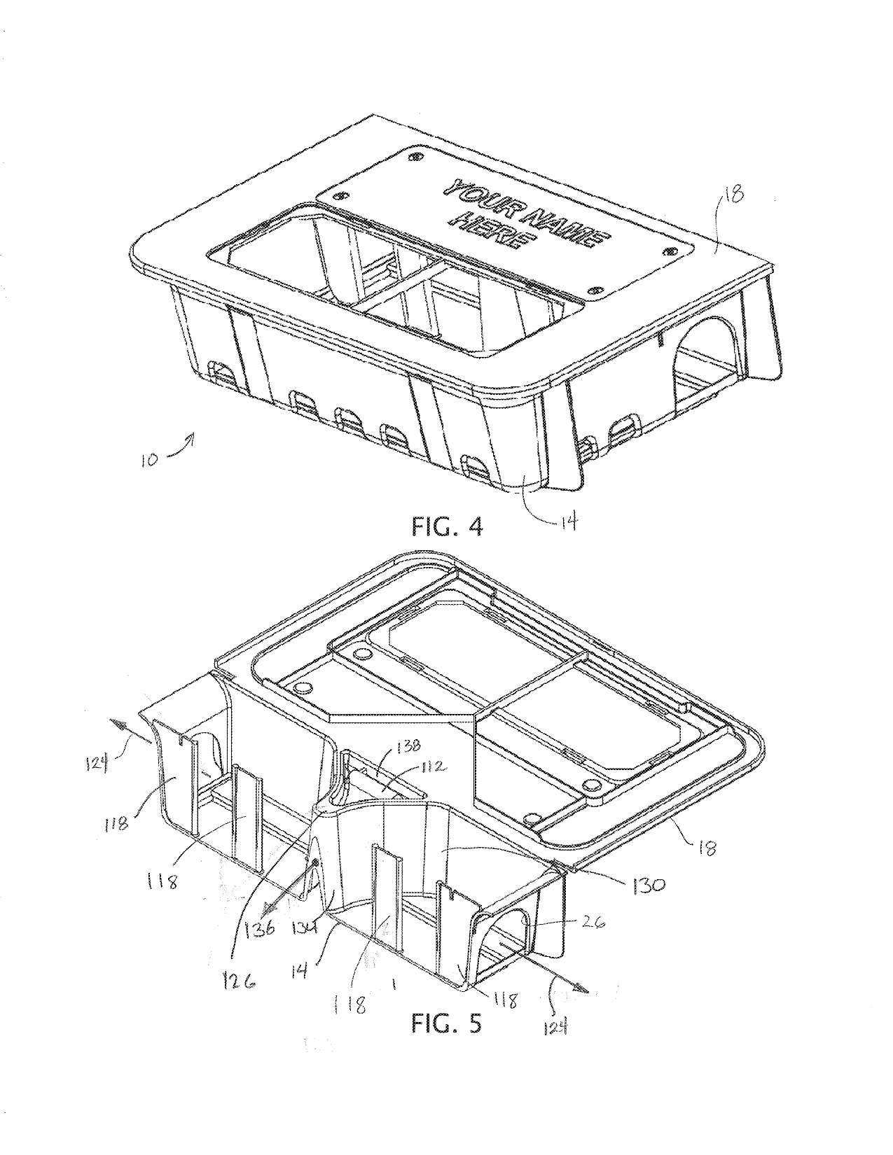

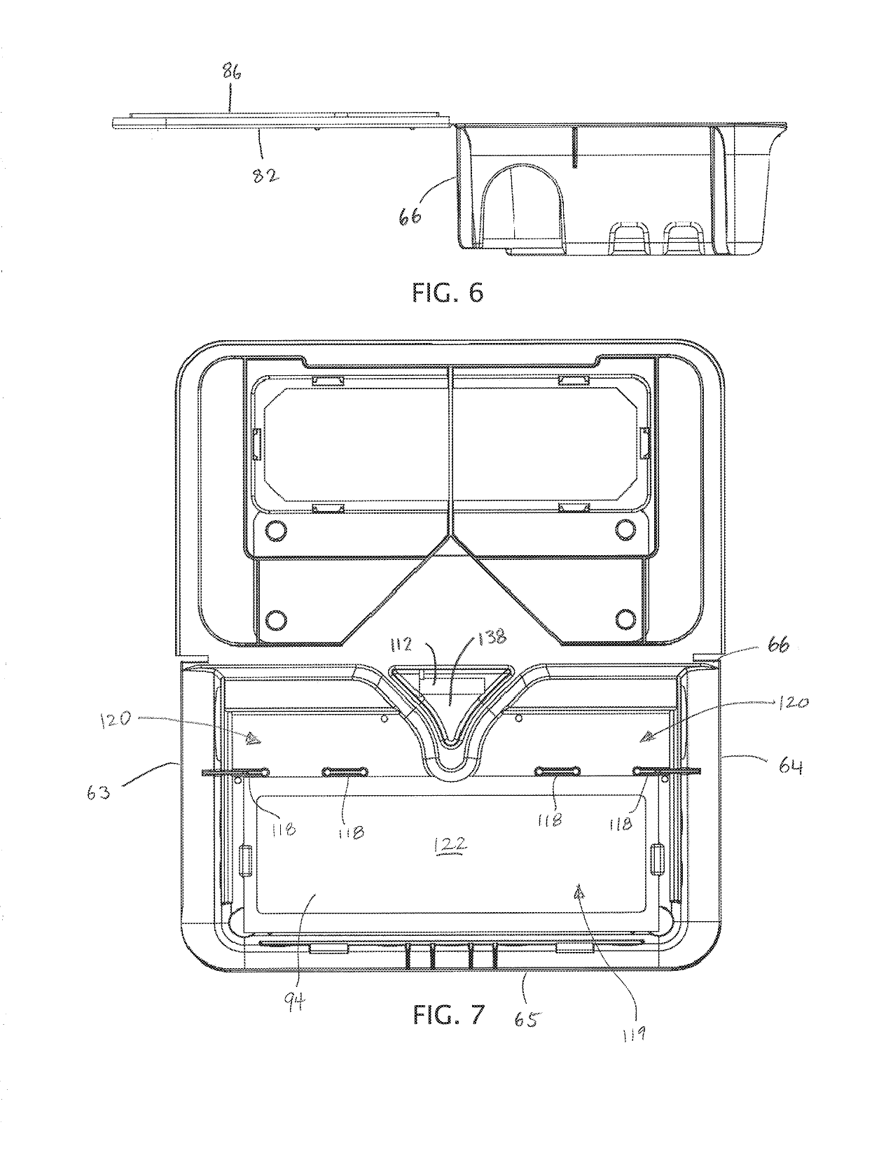

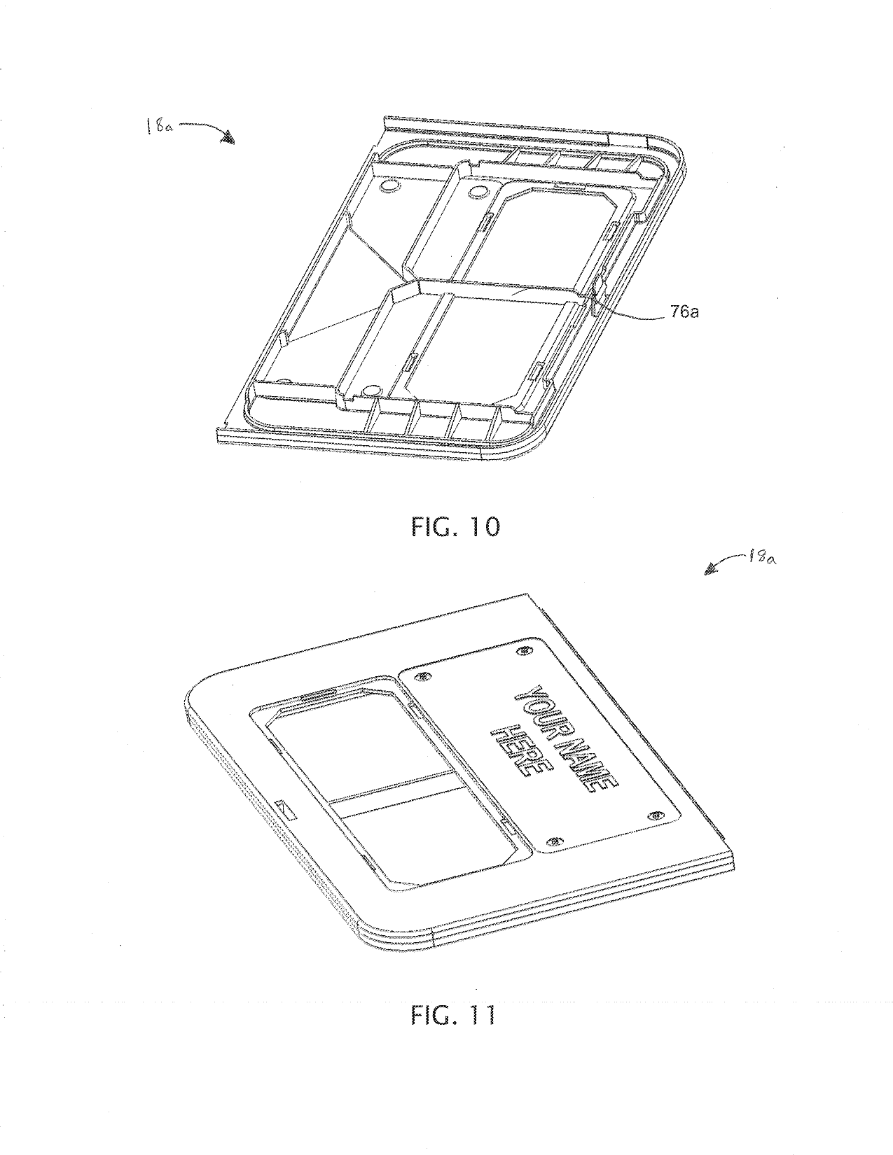

Referring now to the drawings, and more particularly to FIGS. 1-9, shown therein and designated by the reference numeral 10 is one embodiment of the present pest-management apparatuses. In the embodiment shown, apparatus 10 comprises a base 14 and a lid 18 configured to be coupled to (e.g., is shown coupled to) base 14 such that the base and the lid cooperate to define (e.g., when the lid and base are coupled together in a closed configuration, as is shown in FIG. 4) a chamber 22 having at least one entrance opening 26 sized to permit a rodent to enter apparatus 10 (e.g., chamber 22) through opening 26. In some embodiments, base 14 and lid 18 may cooperate to define a chamber having a plurality of (e.g., more than one) entrance openings. For example, in the embodiment shown, base 14 and lid 18 cooperate to define a chamber 22 having a second entrance opening 28. In the embodiment shown, base 14 and lid 18 cooperate to define a chamber 22 having entrance openings 26 and 28 when base 14 and lid 18 are coupled together in a closed configuration (FIG. 4). In the depicted embodiment, entrance openings 26 and 28 are formed only in base 14. Accordingly, one or both of entrance openings 26 and 28 may each be entirely defined by only one of the lid and the base (e.g., the entire perimeter of the respective opening may be defined by only one of the lid and the base). However, in other embodiments, one or both of entrance openings 26 and 28 may each be cooperatively defined by the base and the lid (e.g., when the lid is in a closed configuration relative to the base).

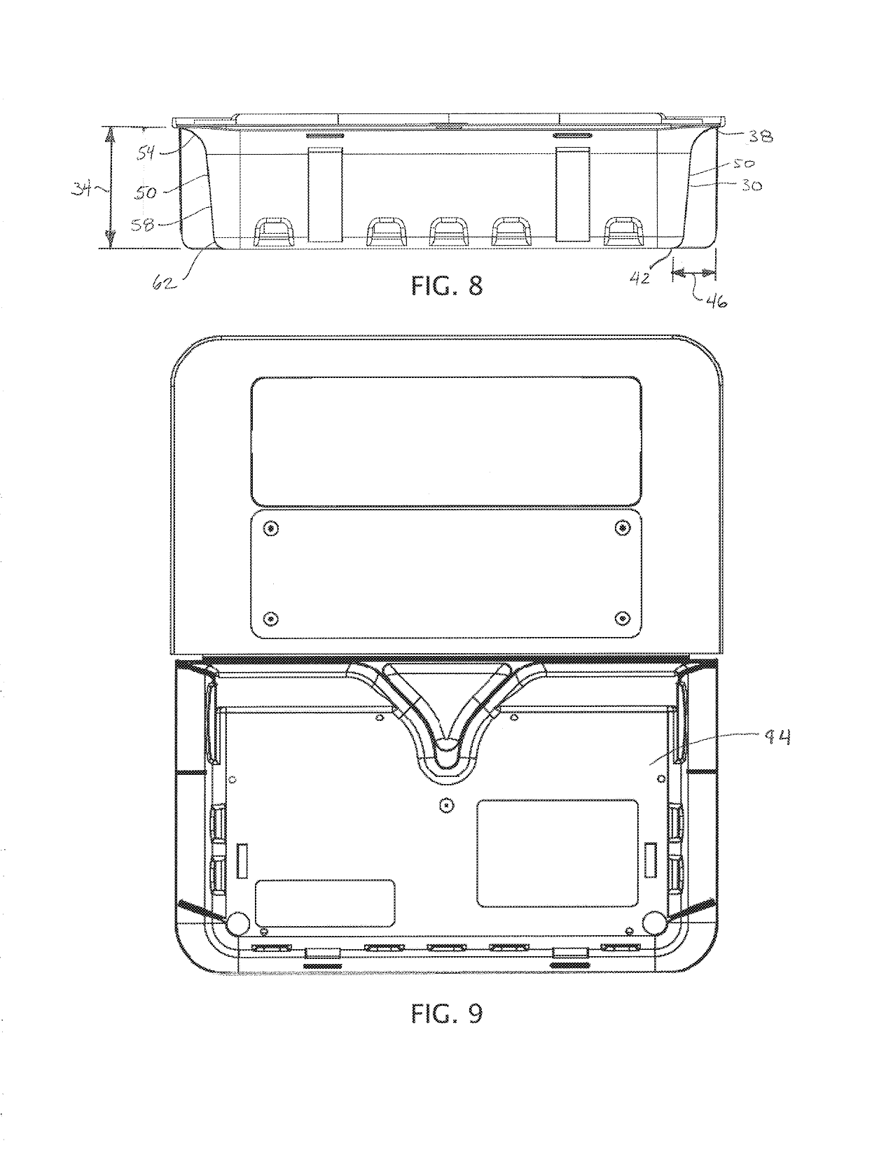

In some embodiments, at least one of base 14 and lid 18 (e.g., base 14, in the embodiment shown) comprises a sidewall 30 at least partially defining an external perimeter of apparatus 10, and configured to discourage a rodent (e.g., at or near sidewall 30) from climbing onto lid 18. More particularly, in some embodiments, at least one of base 14 and lid 18 (e.g., base 14, in the embodiment shown) comprises a sidewall 30 at least partially defining an external perimeter of apparatus 10, and configured with at least a curved portion (e.g., first portion 54) to discourage a rodent (e.g., at or near sidewall 30) from climbing onto lid 18. In the embodiment shown, at least portions of sidewall 30 can also be described as being configured to direct a rodent toward a respective entrance opening 26 or 28. In the embodiment shown, sidewall 30 has a height 34, and an upper portion 38 of sidewall 30 is disposed outwardly (e.g., relative to chamber 22) of a lower portion 42 of the sidewall by a distance 46 (see FIG. 8) of at least 20 percent (e.g., 25, 30, 35, 40, 45, or more percent) of height 34. In the embodiment shown, sidewall 30 includes a surface 50 extending from lower portion 42 to upper portion 38. In the embodiment shown, surface 50 includes a curved (e.g., a concave or substantially arcuate) first portion 54, a substantially straight second portion 58, and a curved (e.g., a convex or substantially arcuate) third portion 62. In other embodiments, surface 50 can have any suitable shape (e.g., can be substantially straight between the lower portion and the upper portion, curved (e.g., concave or convex, including substantially arcuate) between the lower portion and the upper portion, and/or the like).

In the embodiment shown, base 14 can be described as having a left side 63, a right side 64, a front 65, and a back 66. In the embodiment shown, the portions of sidewall 30 along left side 63, right side 64, and front 65 all have substantially similar shapes or profiles, as described above and depicted, for example, in FIG. 8. In the embodiment shown, back 66 has a profile or shape that is different than the shape or profile of left side 63, right side 64, and front 65. In the embodiment shown, back 66 is configured so that it may be disposed adjacent to a substantially vertical surface (e.g., a wall) exterior to apparatus 10 such that the space between back 66 and the substantially vertical surface is minimized (e.g., such that a portion, up to and including all, of back 66 is in contact with the surface). In such embodiments, back 66 may be described as vertically-oriented, or, more specifically, oriented vertically relative to floor 94 of base 14. In other embodiments, back 66 may have a shape or profile that is substantially similar to that of sides 63, 64 and/or front 65 (e.g., that is configured to discourage a rodent from climbing onto lid 18, and/or to direct a rodent toward entrance opening 26 and/or entrance opening 28, and/or the like).

In some embodiments, lid 18 has a first end or edge 68 and a second end or edge 70, and one of end 68 and end 70 is coupled (e.g., pivotally, detachably, etc.) to base 14. For example, in the embodiment shown, edge 70 is coupled to base 14 along back 66. In other embodiments, lid 18 may be configured to be coupled to base 14 along any one or more of sides 63, 64 or front 65. In some embodiments, lid 18 may be configured to be coupled to two or more of sides 63 and 64, front 65, and/or back 66 of base. In the embodiment shown, lid 18 is unitary with base 14 (e.g., base 14 and lid 18 comprise a single piece of material in which lid 18 is pivotally coupled to base 14 via living hinge 72). In the embodiment shown, end 68 of lid 14 is configured to be detachably coupled to base 14 by a lip 74 that is configured to extend around and contact a peripheral edge 76 of base 14 (e.g., when lid 18 is in a closed configuration relative to base 14) to resist separation of the lid from the base (e.g., to resist opening of the lid relative to the base). In other embodiments, lid 18 is configured to be removably coupled to base 14 by at least one latch, lock, and/or the like.

In the embodiment shown, lid 18 comprises at least one transparent viewing window 78 (e.g., one, as shown) through which a user can view at least a portion of chamber 22. In some embodiments, viewing window 78 is at least partially detachable (e.g., via a latch) from lid 18. In some embodiments, viewing window 78 may be unitary with lid 18, such as where the material for lid 18 and window 78 are both transparent. In the embodiment shown, lid 18 comprises a substantially planar portion 82 and a reinforcing portion 86. In the embodiment shown, reinforcing portion 86 comprises one or more ribs 90. In some embodiments, reinforcing portion 86 may comprise any number of reinforcing structures (e.g., ribs, rods, a mesh, etc.) and/or materials (e.g., plastic, steel, aluminum, wood, etc.) configured to reinforce lid 18. In the embodiment shown, reinforcing portion 86 is interior to apparatus 10 when lid 18 is coupled to base 14 in a closed configuration (e.g., FIG. 4). In other embodiments, reinforcing portion 86 may be exterior (e.g., extending outwardly from substantially planar portion 82) to apparatus 10 (e.g., relative to chamber 22) when lid 18 is coupled to base 14 in a closed configuration.

In some embodiments, base 14 comprises a floor 94 configured to prevent movement (e.g., with non-slip material, screws, etc.) of apparatus 10 relative to a surface (e.g., a substantially horizontal surface) on which apparatus 10 is disposed or supported. For example, in some embodiments, a lower or bottom surface of floor may be textured and/or may include a rubber or adhesive surface. In the embodiment shown, floor 94 is unitary with sidewall 30. In other embodiments, floor 94 may be detachably coupled (e.g., via latches) to sidewall 30, or floor 94 may be omitted.

In some embodiments, at least one of base 14 and lid 18 (e.g., base 14, in the embodiment shown) comprises at least one protrusion (e.g., two protrusions, three protrusions, or more) extending outwardly relative to chamber 22. For example, in the embodiment shown, base 14 comprises a plurality of protrusions 106 configured to discourage a rodent from traveling in at least one non-vertical (e.g., horizontal) direction away from entrance opening 26 and/or entrance opening 28. In the embodiment shown, protrusions 106 are unitary with base 14 (e.g., sidewall). In other embodiments, protrusion(s) 106 may be releasably and/or adjustably coupled to at least one of base 14 and lid 18. In the embodiment shown, two protrusions 106 extend from each of sides 63 and 64, with one protrusion at or relatively near front 65 and another protrusion at or relatively near back 66. In other embodiments, protrusion(s) 106 may extend from any suitable portion of base 14 (e.g., any suitable position along sidewall 30, such as, for example, front 65). In the embodiment shown, protrusions 106 extend along substantially the entire height 34 of sidewall 30. In other embodiments, protrusions 106 may extend less than the entire height 34 (e.g., may be vertically shorter than sidewall 30) while still being configured to discourage a rodent from traveling in at least one non-vertical direction away from entrance opening 26 and/or entrance opening 28. In the embodiment shown, protrusions 106 are substantially planar. In other embodiments, protrusion(s) 106 can have any shape (e.g., curved, triangular, etc.) configured to discourage a rodent from traveling in at least one non-vertical direction away from an entrance opening (e.g., 26 or 28). Protrusions 106 may each be disposed at a non-parallel angle (e.g., 90, 75, 60, 45, 30, or less degrees) relative to the portion of sidewall 30 from which the protrusion extends. For example, in the embodiment shown, each protrusion 106 is disposed at an angle of between 60 and 90 degrees relative to the part of sidewall 30 from which it extends, and is substantially perpendicular to floor 94 of the base.

In some embodiments, base 14 and lid 18 cooperate to define a chamber (e.g., 22) having at least one secondary opening 110 (e.g., a plurality of secondary openings 110, as shown) sized differently (e.g., smaller, as shown) than at least one entrance opening (e.g., 26 and/or 28). For example, in the embodiment shown, base 14 defines secondary openings 110. Secondary opening(s) 110 may also be shaped differently than at least one entrance opening (e.g., 26, 28). In other embodiments, the secondary openings can comprise multiple shapes (e.g., square, triangular, circular, etc.). In the embodiment shown, secondary opening 110 are configured to allow pheromones to escape chamber 22 (e.g., to attract pests toward apparatus 10). For example, in the embodiment shown, apparatus 10 is shown with a container (e.g., a tube) 112 configured to hold and release pheromones (and/or scented bait) to attract rodents to apparatus 10. In some embodiments, secondary opening 110 may be configured to allow pests (e.g., cockroaches, scorpions, spiders) smaller than a rodent to enter apparatus 10 (e.g., into chamber 22) while preventing rodents from entering the apparatus through the secondary openings.

In some embodiments, apparatus 10 is configured to prevent liquid below a certain level from entering chamber 22 through the at least one entrance opening (e.g., 26 and 28) and the secondary openings (e.g., 110). For example, in the embodiment shown, the bottom or lowermost portions of each of entrance openings 26 and 28, and of secondary openings 110 are disposed a distance above the bottom of floor 94 (e.g., as defined by a raised edge 114) to resist and/or prevent liquid on a surface on which the apparatus is disposed from entering through the openings.

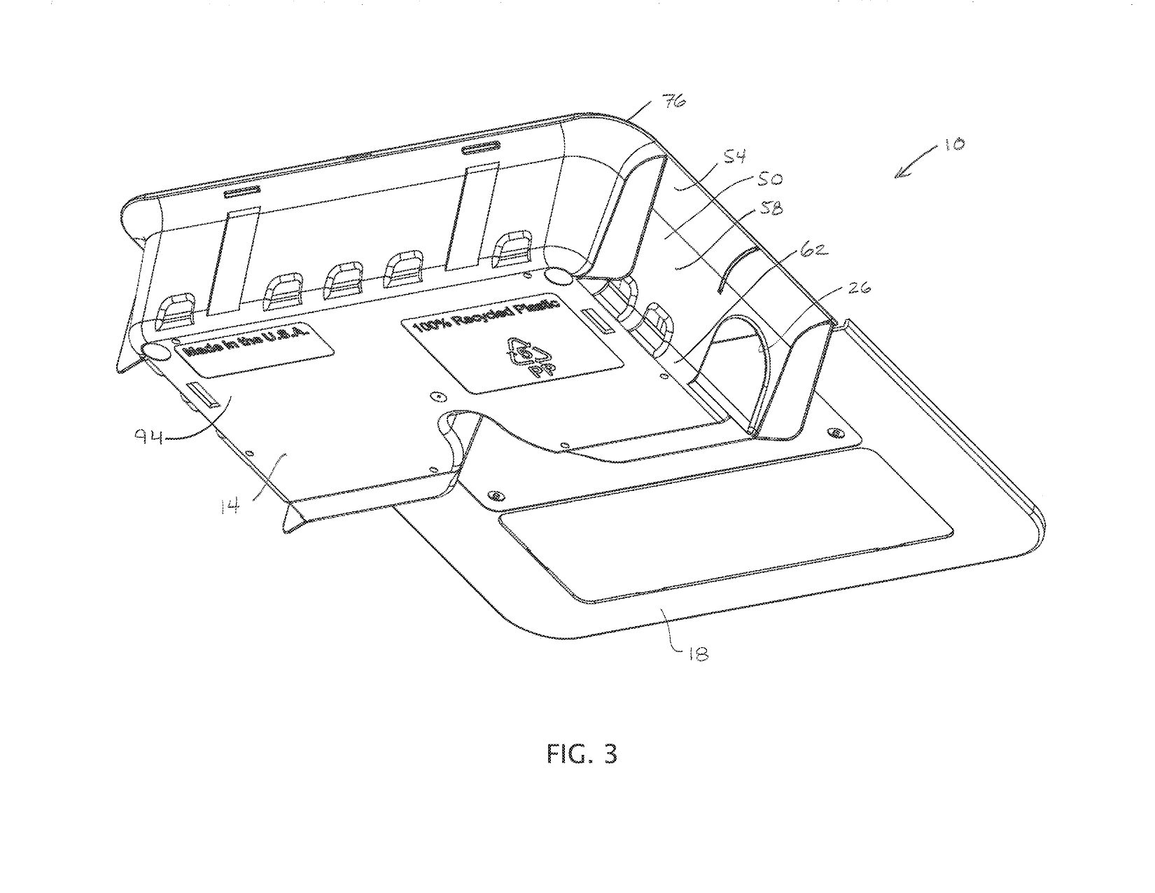

In some embodiments, apparatus 10 comprises one or more separators (e.g., four separators 118, as shown) configured such that if lid 18 and base 14 are coupled together to define chamber 22 (e.g., in a closed configuration), the separator(s) divide chamber 22 into a rodent capture portion 119 and an entry portion 120 (FIG. 5). In the embodiments shown in FIG. 5, rodent capture portion 119 and entry portion 120 are in fluid communication. In the embodiment shown, four separators 118 are spaced to define multiple pathways through which rodents can travel from entry portion 120 to rodent capture portion 119. In the embodiment shown, base 14 is configured and, more specifically, separators 118 and/or divider 126 are configured, such that if multiple rodents enter apparatus 10, the shape of the base and, more specifically, the separators and/or the divider, may function to direct each rodents to different parts of rodent capture portion 119 of chamber 22. For example, in the embodiment shown, spaces are provided between separators 118 such that if a first rodent enters capture portion 119 through a first one of the spaces and becomes trapped at the corresponding part of rodent capture portion 119, then a subsequent rodent may be directed to a second “unoccupied” one of the spaces between the separators such that the subsequent rodent can enter and become trapped at a part of rodent capture portion 119 corresponding to the second one of the spaces (e.g., if apparatus 10 comprises more than one space between separators 118). In some embodiments, one or more separators 118 may be configured or disposed to encourage rodents to enter rodent capture portion 119. Separators 118 can be coupled (e.g., releasably, detachably, etc.) to at least one of lid 18 and base 14. For example, in the embodiment shown, separators 118 are unitary with base 14 (e.g., sidewall 30 and/or floor 94). In the embodiment shown, separators 118 are substantially planar. In other embodiments, separators 118 may have any shape that permits them to function as described in this disclosure. In the embodiment shown, separators 118 are substantially perpendicular to floor 94. In other embodiments, one or more of separators 118 may be oriented at a non-parallel angle (e.g., 75, 60, 45, or less degrees) relative to floor 94. In the embodiment shown, separators 118 are substantially parallel to front 65 and/or back 66. In other embodiments, one or more separators 118 may be oriented at a non-parallel angle (e.g., 75, 60, 45, or less degrees) to front 65 and/or back 66) configured to encourage rodents to enter rodent capture portion 119. In some embodiments, at least one of separators 118 may be oriented, sized, and/or shaped differently than at least one other of separators 118. In the embodiment shown, separators 118 are disposed such that the width (measured in a direction extending from front 65 to back 66) of entry portion 120 is less than a length (measured in a direction extending from side 63 to side 64) of entry portion 120, and may be sized (e.g., with a width that is small enough) to discourage rodents within a certain size range from turning around in entry portion 120 (and thereby from exiting apparatus 10 without entering and/or becoming trapped in rodent capture portion 119).

In the embodiment shown, rodent capture portion 119 of chamber 22 is configured to resist a rodent's exit from apparatus 10. In some embodiments, an adhesive 122 (e.g., an adhesive mat) is disposed in rodent capture portion 119 of chamber 22 (e.g., coupled to floor 94). In other embodiments, rodent capture portion 119 may contain any suitable rodent capture means (e.g., snap traps) and/or bait (e.g., bait configured to kill a pest, such as poison).

In the embodiment shown, entry portion 120 of chamber 22 is in fluid communication with entrance opening 26 and with entrance opening 28. In the embodiment shown, entry portion 120 provides an entryway for a rodent entering through one of entrance openings 26, 28 to access rodent capture portion 119. In the embodiment shown, entrance openings 26 and 28 are disposed on substantially opposite sides (e.g., right side 64 and left side 63, respectively) of apparatus 10. In the embodiment shown, entrance opening 26 and entrance opening 28 are configured such that an axis 124 extends through both of openings 26 and 28 (e.g., such that axis 124 is substantially parallel to floor 94). In other embodiments, axis 124 may extend through the entrance openings at an angle that is not perpendicular (e.g., 75, 60, 45, or less degrees) to the respective planes of openings 26 and 28. In other embodiments, entrance openings 26 and 28 may be disposed at any suitable positions relative to sides 63 and 64, front 65, and/or back 66.

In some embodiments, at least one of base 14 and lid 18 (e.g., base 14, in the embodiment shown) comprises at least one divider disposed in entry portion 120. For example, in the embodiment shown, base 14 includes a divider 126 that is configured to prevent a rodent from entering apparatus 10 through one entrance opening (e.g., 26) and exiting apparatus 10 through another entrance opening (e.g., 28) without first passing through rodent capture portion 119. In the embodiment shown, divider 126 is further configured to prevent a rodent outside apparatus 10 from seeing one entrance opening (e.g., 28) through the other entrance opening (e.g., 26). In the embodiment shown, divider 126 is further configured to encourage rodents (e.g., in entry portion 120) to enter rodent capture portion 119. In some embodiments, divider 126 extends inward from and/or is coupled (e.g., releasably, detachably, etc.) to sidewall 30. For example, in the embodiment shown, divider 126 is unitary with sidewall 30. In the embodiment shown, divider 126 is disposed substantially midway between entrance opening 26 and entrance opening 28. In other embodiments, divider 126 may be disposed closer to one entrance opening than another entrance opening. In the embodiment shown, divider 126 has a first end 130 and a second end 134 disposed closer to rodent capture 102 portion than first end 130. In the embodiment shown, first end 130 is wider than second end 134. In the embodiment shown, divider 126 is symmetric about an axis 136 such that divider 126 appears substantially similar whether viewed through entrance opening 26 or entrance opening 28. In the embodiments, second end 134 of divider 126 is a greater distance from the center of entrance opening 26 than at least a portion of first end 130. In some embodiments, first end 130 and second end 134 are substantially the same distance from the center of entrance opening 26. In the embodiment shown, an upper portion of divider 126 includes a recess 138 configured to receive container 112 with and/or directly receive pheromones and/or bait (e.g., scented bait) configured to attract rodents.

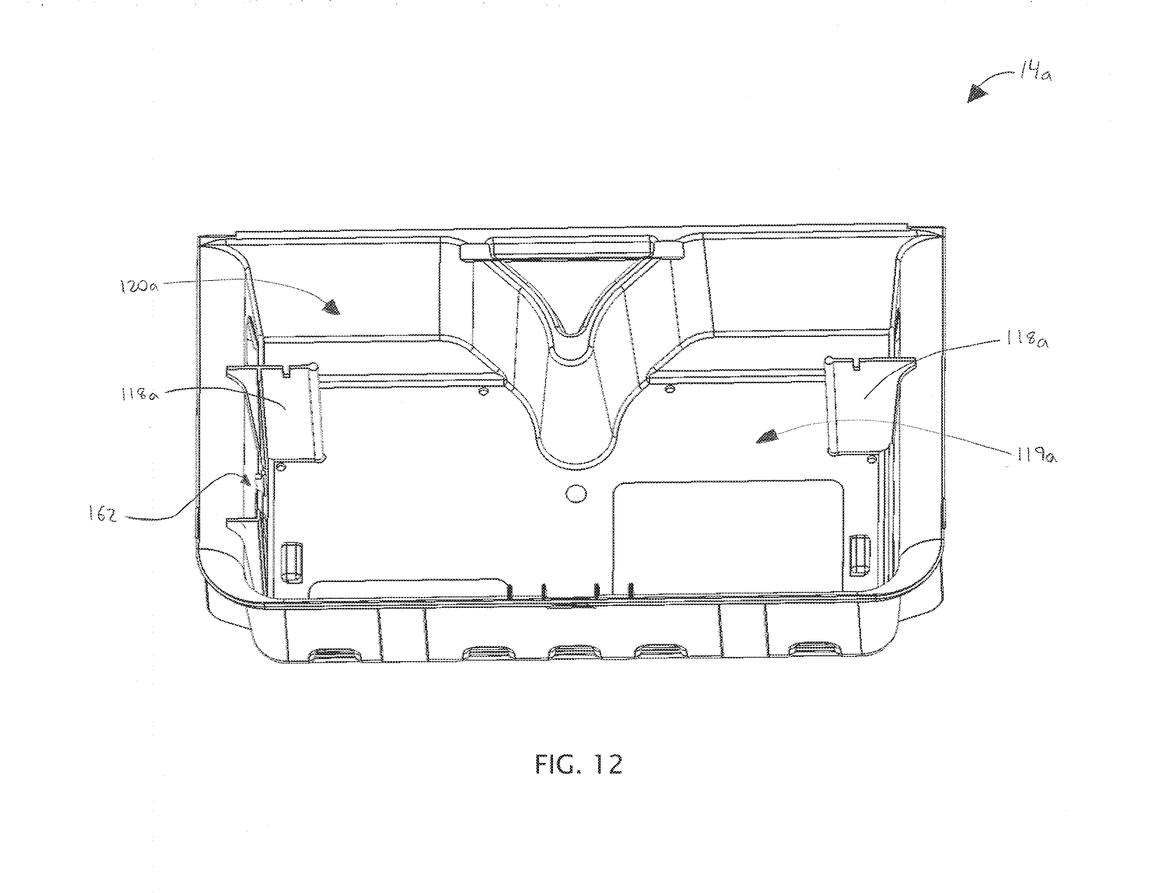

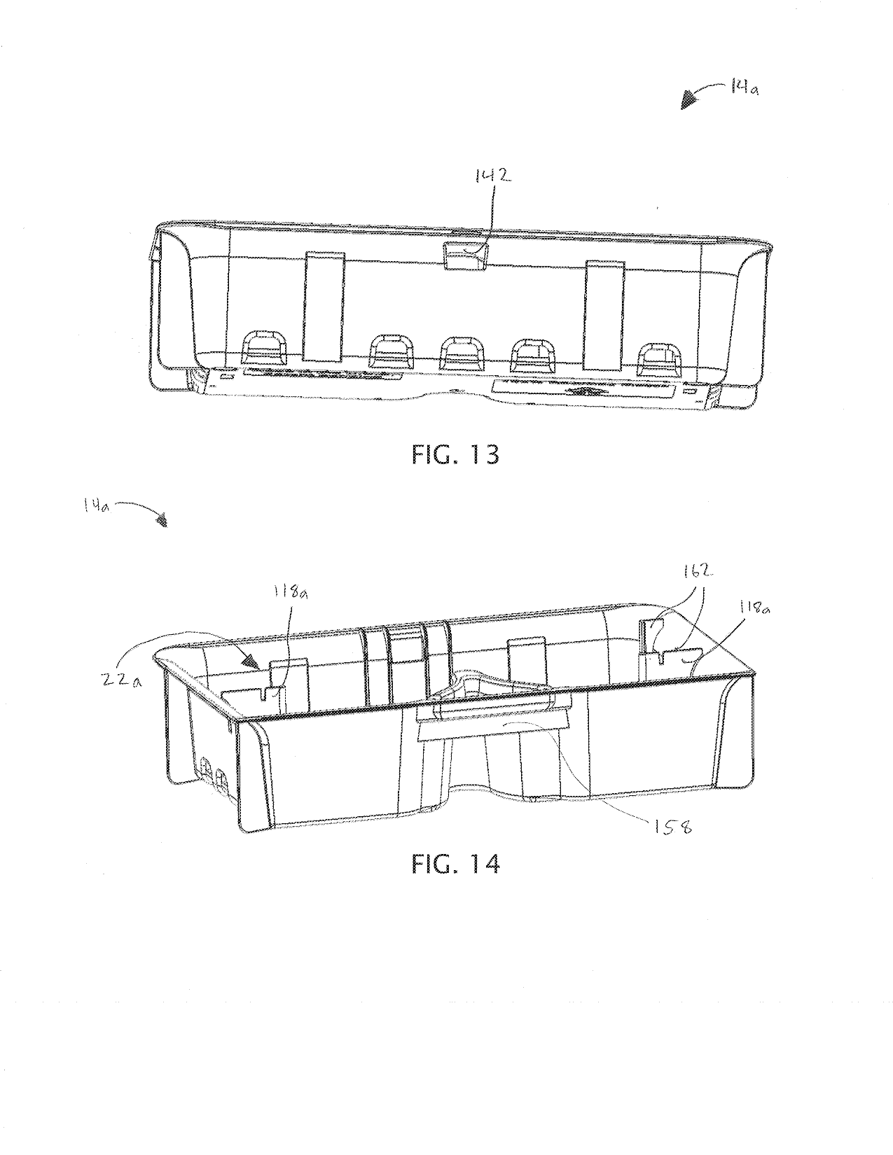

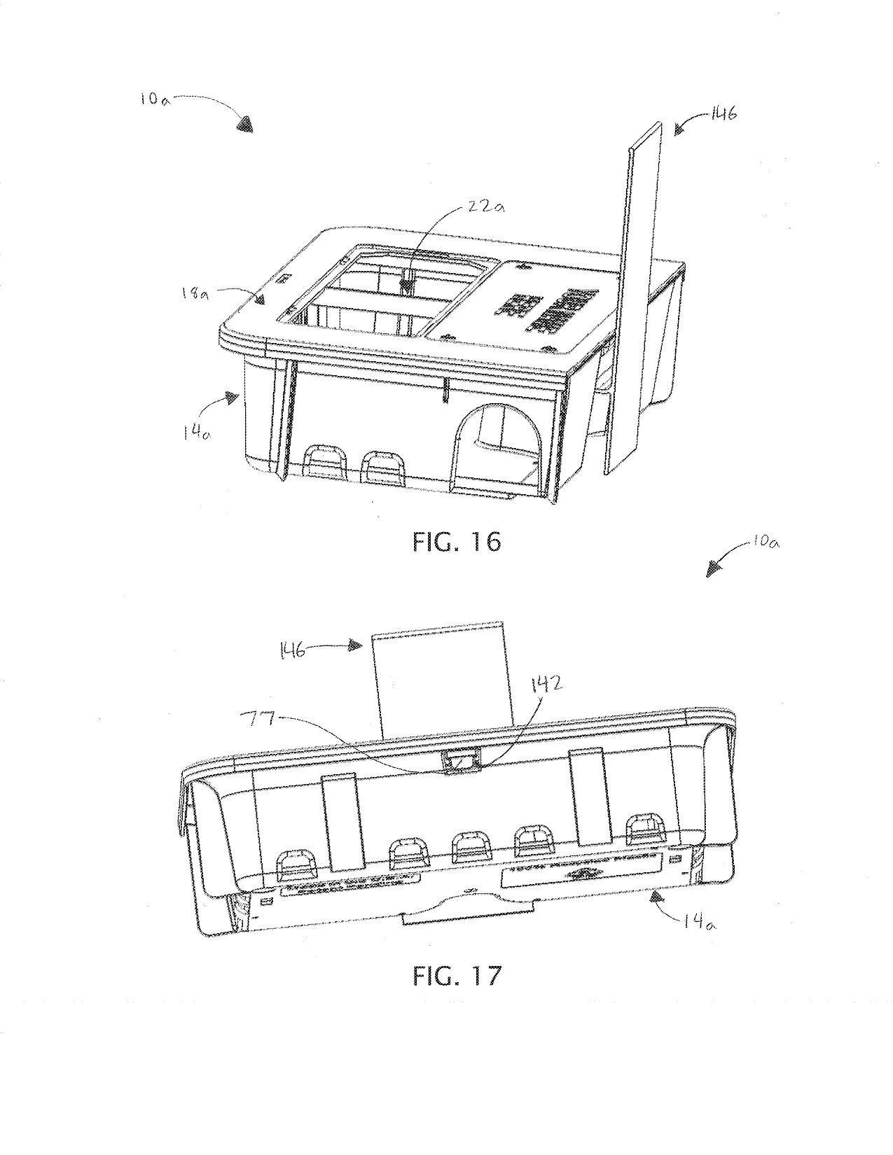

Referring now to FIGS. 10-14 and 16-17, shown therein and designated by the reference numeral 10a is another embodiment of the present pest-management apparatuses. Apparatus 10a is similar in many respects to apparatus 10, and the differences in apparatus 10a relative to apparatus 10 are therefore primarily described here. While several differences in apparatuses 10a are described here, additional differences may be depicted in the figures. FIGS. 10-11 depict another embodiment 18a of a lid of the present pest-management apparatuses (e.g., apparatus 10a); and FIGS. 12-14 depict another embodiment 14a of a base of the present pest-management apparatuses (e.g., apparatus 10a). In the embodiment shown, lid 18a is configured to be coupled to (e.g., pivotally, detachably, etc.) base 14a (e.g., depicted in FIGS. 16-17).

In the embodiment shown, lid 18a can comprise a latch 76a configured to resist separation of lid 18a and base 14a when lid 18a is in a closed configuration relative to base 14a. For example, in the embodiment shown, latch 76a is configured to engage a corresponding lip or shelf 77 in base 14a. In some embodiments, at least one of base 14a and lid 18a comprises a release opening configured to permit a user to release lid 18a relative to base 14a to permit the apparatus to transition from a closed configuration to an open configuration. For example, in the embodiment shown, base 14a comprises release opening 142 that permits a user's finger or other object to extend through release opening to depress latch 76a relative to shelf 77. For example, The at least one of base 14a and lid 18a that comprises the release opening(s) can be configured such that the edge(s) defining the release opening are configured to prevent a user from injury. (e.g., if a user extends a finger through the release opening), such as, for example, via beveled edges, edges comprising a radius, and similarly smoothed edges. For example, in the embodiment shown, the edges of base 14a that define release opening 142 are rounded or radiused to eliminate or exclude sharp edges that could otherwise injure or irritate the skin of a user that extends a finger through release opening to release latch 76a.

In some embodiments, apparatus 10a comprises one or more separators 118a (e.g., two separators 118a, as depicted in FIG. 12) configured such that if lid 18a and base 14a are coupled together to define chamber 22a (e.g., in a closed configuration), the separator(s) divide chamber 22a into a rodent capture portion 119a and an entry portion 120a. For example, in apparatus 10a, rodent capture portion 119a and entry portion 120a are in fluid communication and base 14a includes only two separators 118a that are spaced to define pathways through which pests (e.g., rodents) can travel from entry portion 120a to rodent capture portion 119a that are relatively larger than the pathways between separators 118 of base 14.

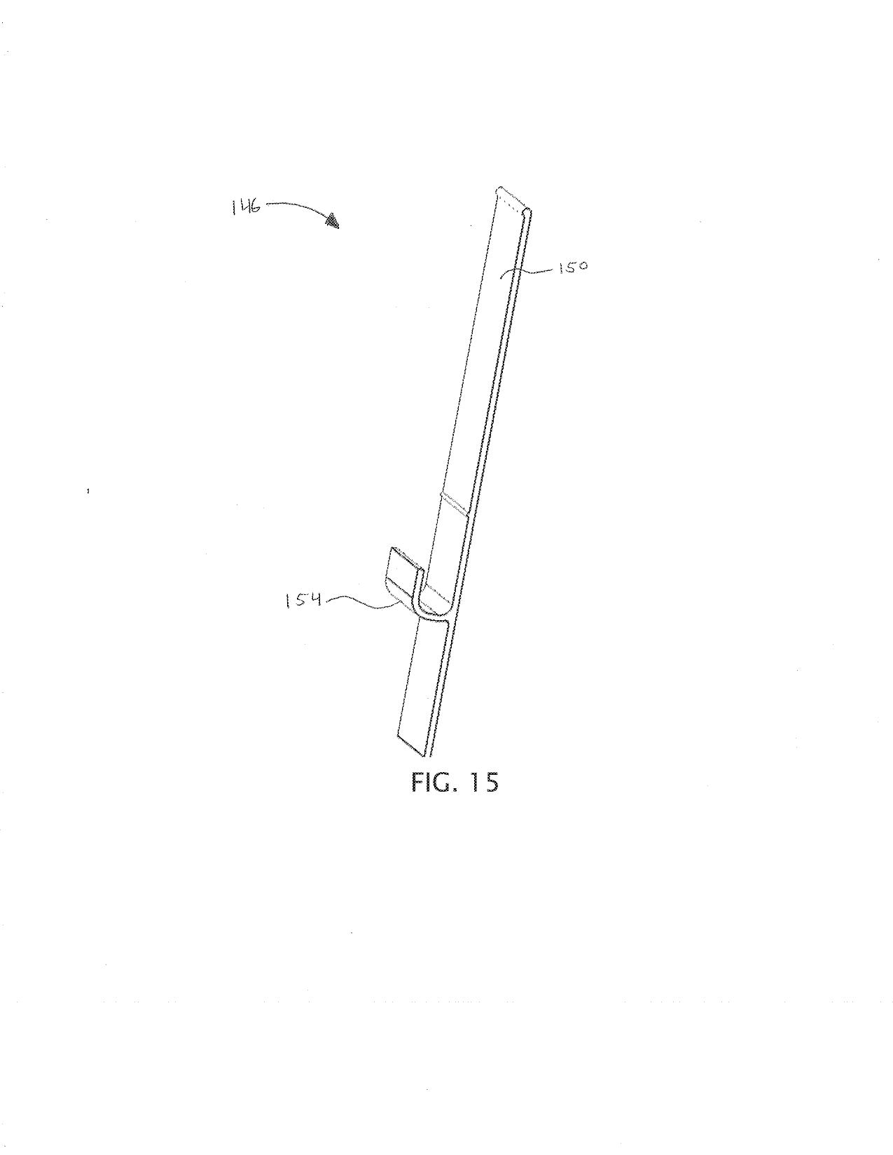

FIG. 15 depicts an embodiment 146 of a coupling member that is configured to be coupled to a surface (e.g., a substantially vertical surface (e.g., a wall) exterior to apparatus 10a) such as, for example, by one or more adhesives, bolts, screws, nails, and similar coupling devices. In the embodiment shown, coupling member 146 comprises a primary (e.g., planar, in the embodiment shown) portion 150 and a retaining portion 154 (e.g., which is substantially curved in the embodiment shown) that is configured to be coupled to apparatus 10a. Coupling member 146 is configured to be used with apparatus 10a such that when (e.g., if) apparatus 10a is disposed adjacent to a surface (e.g., a wall), and coupling member 146 is coupled to the surface and to apparatus 10a, coupling member 146 substantially prevents apparatus 10a from moving away from the surface (e.g., in one or more horizontal or other non-vertical directions).

In some embodiments, at least one of base 14a and lid 18a is configured to be coupled to coupling member 146 (e.g., as depicted in FIGS. 16-17). For example, in the embodiment shown, base 14a comprises a coupling portion 158 (FIG. 14) that is configured to be coupled to (e.g., overlap) retaining portion 154 of coupling member 146. In this embodiment, a user can couple base member 150 of coupling member 146 to a (e.g., vertical) surface and can dispose apparatus 10a such that retention portion 158 is disposed between retaining portion 154 and base portion 150 of coupling member 146, such that when (e.g., if) a horizontal or other non-vertical separating force is applied to apparatus 10a in a direction away from primary portion 150 of coupling member 146, retaining portion 154 can apply a retaining force to retention portion 158 of base 14a to prevent apparatus 10a from moving in the direction of the separating force.

In the embodiment shown, a portion of coupling member 146 (e.g., part of primary portion 150) can—but is not required to—extend (e.g., vertically) beyond lid 18a of apparatus 10a when apparatus 10a is coupled to coupling member 146 to permit a user to distinguish one apparatus from other similar apparatuses. For example, a number or other indicator can be indicated or displayed on the part of primary portion 150 that extends above lid 18a (e.g., via sticker, pre-printed number or numeral, or via handwriting applied with a pen or the like). In some embodiments, at least one of base 14a and lid 18a can comprise slot 162 interior to apparatus 10a (e.g., within chamber 22a) configured to permit a user to dispose a card with information relating to apparatus 10a in slot 162 (e.g., service records, metrics relating to the apparatus, and/or the like).

In the embodiments shown, apparatuses 10 and 10a (e.g., at least one of and/or both of bases 14 and 14a and lids 18 and 18a, respectively) may comprise plastic. For example, in some embodiments, bases 14 and 14a and/or lids 18 and 18a comprise a plastic selected from the group consisting of: polypropylene (PP), polystyrene (PS), high impact polystyrene (HIPS), acrylonitrile butadiene styrene (ABS), polyethylene terephthalate (PET), polyvinyl chloride (PVC), polycarbonate (PC), polyethylene (PE), and polycarbonate/acrylonitrile butadiene styrene (PC/ABS), polycarbonate polybutylene terephthalate (PBT), acrylonitrile styrene acrylate (ASA), polyurethanes, nylon (often referred to as polyamide (PA)), combinations thereof, and/or other plastics or polymers. In other embodiments, apparatuses 10 and 10a (e.g., at least one of and/or both of bases 14 and 14a and lids 18 and 18a, respectively) comprise a non-plastic material, such as, for example, a metal (e.g., steel, iron, aluminum, copper, brass, or the like), fiberglass, carbon fiber, synthetic materials, and other suitably durable or rigid materials.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A pest-management apparatus comprising:
a base; and
a lid configured to be coupled to the base such that the base and the lid cooperate to define a chamber having at least one entrance opening sized to permit a rodent to enter the apparatus through the at least one entrance opening;
where at least one of the base and the lid comprises a sidewall at least partially defining an external perimeter of the apparatus, the sidewall configured to discourage a rodent from climbing onto the lid of the apparatus.

2. The apparatus of claim 1, where the base comprises the sidewall that is configured to direct a rodent toward the at least one entrance opening.

3. (canceled)

4. The apparatus of claim 1, where the sidewall has a height, and an upper portion of the sidewall is disposed outwardly of a lower portion of the sidewall by a distance of at least 20 percent of the height.

5. The apparatus of claim 4, where the sidewall includes a surface extending from the lower portion to the upper portion, the surface including a concave-shaped first portion and a substantially-straight second portion.

6-11. (canceled)

12. The apparatus of claim 1, where the lid comprises a transparent viewing window through which a user can view at least a portion of the chamber.

13-18. (canceled)

19. The apparatus of claim 1, where at least one of the base and the lid comprises at least one protrusion extending outwardly relative to the chamber, the at least one protrusion configured to discourage a rodent from traveling in at least one non-vertical direction away from the at least one entrance opening.

20. The apparatus of claim 19, where the at least one protrusion extends from the sidewall.

21. (canceled)

22. The apparatus of claim 1, where the chamber has at least one secondary opening sized differently than the entrance opening.

23-24. (canceled)

25. The apparatus of claim 22, where the at least one secondary opening includes a plurality of secondary openings that are each smaller than the at least one entrance opening.

26-32. (canceled)

33. The apparatus of claim 1, where the apparatus is configured to be coupled to a coupling member such that if the coupling member is coupled to the surface, the coupling member substantially prevents the apparatus from moving away from the surface.

34. (canceled)

35. The apparatus of claim 33, where the coupling member comprises:
a planar portion; and
a retaining portion;
where the apparatus is configured to be coupled to the retaining portion.

36. A pest-management apparatus comprising:
a base; and
a lid configured to be coupled to the base such that the base and the lid cooperate to define a chamber having at least one entrance opening sized to permit a rodent to enter the apparatus through the at least one entrance opening;
where at least one of the base and the lid comprises at least one protrusion extending outwardly relative to the chamber, the at least one protrusion configured to discourage a rodent from traveling in at least one non-vertical direction away from the at least one entrance opening.

37. The apparatus of claim 36, where at least one of the base and the lid comprises a sidewall at least partially defining an external perimeter of the apparatus, and the at least one protrusion extends from the sidewall.

38. (canceled)

39. The apparatus of claim 37 where the sidewall is configured to discourage a rodent from climbing onto the lid of the apparatus.

40. The apparatus of claim 37, where the sidewall is configured to direct a rodent toward the at least one entrance opening.

41. The apparatus of claim 37, where the sidewall has a height, and an upper portion of the sidewall disposed outwardly of a lower portion of the sidewall by a distance of at least 20 percent of the height.

42. The apparatus of claim 41, where the sidewall includes a surface extending from the lower portion to the upper portion, the surface including a concave-shaped first portion and a substantially straight second portion.

43-55. (canceled)

56. The apparatus of claim 1, where the apparatus is configured to be coupled to a coupling member such that if the coupling member is coupled to the surface, the coupling member substantially prevents the apparatus from moving away from the surface.

57. (canceled)

58. The apparatus of claim 56, where the coupling member comprises:
a planar portion; and
a retaining portion;
where the apparatus is configured to be coupled to the retaining portion.

59. A pest-management apparatus comprising:
a base; and
a lid configured to be coupled to the base such that the base and the lid cooperate to define a chamber having at least one entrance opening sized to permit a rodent to enter the chamber and at least one secondary opening sized differently than the entrance opening.

60. The apparatus of claim 59, where the at least one secondary opening is shaped differently than the at least one entrance opening.

61. (canceled)

62. The apparatus of claim 59, where the at least one secondary opening includes a plurality of secondary openings that are each smaller than the at least one entrance opening.

63. The apparatus of claim 59, where the at least one entrance opening and at least one secondary opening is disposed vertically from the ground to prevent fluid entry.

64. The apparatus of claim 59, where at least one of the base and the lid comprises a sidewall at least partially defining an external perimeter of the apparatus, the sidewall configured to discourage a rodent from climbing onto the lid of the apparatus.

65-127. (canceled)
